(19) United States
(12) Patent Application Publication
(10) Pub. No.: US 2011/0318557 A1
(43) Pub. Date: Dec. 29, 2011

(54) MDO POLYPROPYLENE LINER

(75) Inventor: Noel MITCHELL, Wuppertal (DE)

(73) Assignee: UPM Raflatac Oy, Tampere (FI)

(21) Appl. No.: 12/821,203

(22) Filed: Jun. 23, 2010

(51) Int. Cl. C08L 23/12; B32B 27/32

(52) U.S. Cl. 428/220; 525/185; 524/502

(57) ABSTRACT

The invention relates to a machine direction oriented plastic film as a release liner for a pressure-sensitive label, wherein the plastic film comprises a polypropylene homopolymer and a hydrocarbon resin. The invention also relates to a method for producing a release liner for pressure-sensitive label. In the method at least one polypropylene homopolymer is selected as one component and at least one hydrocarbon resin is selected as another component. A relative amount of the at least one hydrocarbon resin in a mixture of the at least one polypropylene and at least one hydrocarbon resin is selected, the at least one polypropylene homopolymer component and the at least one hydrocarbon resin component are mixed in said relative amount by melt processing to form a monolayer or multilayer plastic film. Said plastic film is oriented in a machine direction; and the machine-direction oriented plastic film is coated with a releasing agent to form a release liner.

### FIELD OF THE INVENTION

The present invention relates to a pressure-sensitive laminate construction, especially to a backing material used in laminate constructions for pressure-sensitive labels.

### BACKGROUND OF THE INVENTION

One possible and well-known construction of a pressure-sensitive laminate for pressure-sensitive labels or other products produced from the laminate consists of layers such as a release liner, also referred as a backing material, and a face material which are laminated together with a pressure-sensitive adhesive layer in between. This kind of construction is also referred to as a labelstock or release-lined laminate hereinafter. Pressure sensitive label is also known as self-adhesive label or self-stick label.

The release liner is used to protect the adhesive and allow for efficient handling up to the point where the label face material is dispensed and adhered to a substrate surface. A face material is used as a top layer of the label, also referred to a facestock, and is the layer that is attached to another surface with an adhesive. There exists also release-linerless self-adhesive labelling systems without a protective backing material, but these are special purpose systems not suited for all applications.

The release liner may be, for example, a plastic film or a glassine paper or kraft paper. Release liner is usually coated with a thin layer of a release agent such as silicone. Due to the release properties of the backing material, the release liner can be easily removed to expose the pressure sensitive adhesive for adhering the label to a substrate. The release liner is also referred to simply as liner hereinafter.

A general advantage of the plastic film liners is the smoothness of the surface compared to traditional paper liners. Smooth surface of a plastic liner will further generate smoothness of the adhesive coating transferred to the face material. Smooth adhesive layer is benefit for example when clarity of transparent labels is preferred. Plastic liners have also better mechanical properties which is an advantage in automatic labelling lines where machinery must dispense and apply labels at high speed. Plastic liners have, for example, reduced occurrence of liner breakages and thus reduced productivity losses on the dispensing and bottling lines.

According to prior art most commonly used plastic liners are silikonized biaxially oriented polyester films. Typically these liners, even in thickness of 20 microns, exhibit high tensile strength, low elongation and good heat resistance. However polyester liners are higher priced than corresponding paper liners and their recycling is highly energy consuming process. Silicone will also interfere with the visual appearance causing milkiness of the polyester articles produced from recycled material.

Biaxially oriented polypropylene (BO-PP) liners are also used. In comparison to polyester liners, BO-PP liners generally exhibit lower tensile strength and higher elongation in the machine direction, particularly at elevated temperatures. Thus, for example, biaxially oriented PP liners tend to shrink excessively during the adhesive drying process.

Monoaxially oriented polypropylene liners are used to a lesser extent. They tend to be relatively thick compared to biaxially oriented polyester or polypropylene liners and have relatively poor dimensional stability, even in thickness of greater than 50 microns. However, in label industry, monoaxially films would be preferred as the manufacturing equipment for a machine direction orienting (MDO) line is much lower in cost than the cost of a biaxial orienting (BO) line. The lower production output of an MDO-line than that of a BO-line may also be advantage in label industry since special formulations in relatively small quantities could not be economically produced on a BO-line.

In the economical point of view, thin label laminate constructions and thin liners are preferred due to the decreased material costs and these also allow more labels per roll and reduced number of roll changes increasing labelling efficiency. It is also desired that that plastic film for release liner should have high degree of mechanical stability, particularly in machine direction of the plastic film, because of the high tension and stress placed on the film in that direction, during further processes such as printing, die-cutting and dispensing of the label. The liner should not elongate under the high tension and stress placed upon it, even under warm conditions experienced, for example when operating a printing press for lengthy periods. The waste material between the labels (matrix), which is stripped away and reeled up after die-cutting operation, should be strong enough not to break, and the liner should not tear at high-speeds during the dispensing operation when the liner is removed from label and the label is attached to the substrate surface. It is further desired that labelstocks are environmental friendly and liner material is recyclable and may be reused.

### SUMMARY OF THE INVENTION

It is an object of the present invention to provide more economical plastic film used as a release liner for pressure-sensitive labels with reduced material costs while at the same time maintaining the adequate properties like mechanical stability of the plastic film. Another object of the invention is to form release liner which is easily recyclable.

According to first aspect of the invention there is provided a machine direction oriented (MDO) plastic film as release liner for a pressure-sensitive label. MDO plastic film may comprise at least one polypropylene homopolymer as a main component and hydrocarbon resin as a minor component. The hydrocarbon resin may be, for example, hydrogenated, saturated aliphatic acyclic or saturated aliphatic cyclic hydrocarbon resin.

According to an embodiment of the invention the MDO plastic film may be a monolayer or a multilayer film having a thickness of around 20 microns, for example 15-35 microns.

According to one embodiment of the invention the MDO film may include hydrocarbon resin from 3 to 20 weight-% or from 8 to 15 weight-%.

According to another embodiment of the invention the MDO plastic film may also include a mineral filler. The amount of the mineral filler may be from 2 to 50 weight-% or from 10 to 30 weight-%.

According to still another aspect of the invention there is provided a method to produce a release liner for pressure-sensitive label, the method comprising at least the following steps:
selecting at least one polypropylene homopolymer,
selecting at least one hydrocarbon resin,
selecting a relative amount of the at least one hydrocarbon resin in the mixture of the at least one polypropylene and at least one hydrocarbon resin,
mixing the at least one polypropylene homopolymer and the at least one hydrocarbon resin component in said relative amount by melt processing to form a monolayer or multilayer plastic film,
orienting said plastic film in a machine direction; and
coating the machine-direction oriented plastic film with a releasing agent to form a release liner.

### DESCRIPTION OF THE DRAWINGS

FIG. 1 is a cross-sectional view showing an example construction of release-lined laminate for pressure sensitive label and an example embodiment of a release liner according to the invention.

FIG. 2a is a cross-sectional view showing an example construction of release-lined laminate for pressure sensitive label and another example embodiment of a release liner according to the invention.

FIG. 2b is a cross-sectional view showing an example construction of a multilayer release liner comprising a MDO multilayer plastic film.

### DETAILED DESCRIPTION OF THE INVENTION

Hereinafter, preferable embodiments according to the present invention will be described. The embodiments are only exemplary embodiments of the invention and a person skilled in the art recognized readily that they may be combined in various ways to generate further embodiments without deviating from the invention.

According to this invention a machine direction oriented plastic film comprises at least one polypropylene (PP) homopolymer as a main component and at least one hydrocarbon (HC) resin as a minor component. Mixing of these components in order to form non-oriented plastic films may be done by conventional melt processing techniques such as blown-film or cast-film extrusion. PP homopolymer consists only propylene as repeat monomer unit. According to one embodiment of the invention the plastic film comprise from 3 to 20 weight-% or from 8 to 15 weight-% of hydrocarbon resin. Hydrocarbon resin may be a hydrogenated or saturated aliphatic acyclic or saturated aliphatic cyclic (cycloaliphatic) hydrocarbon compound or a mixture of two or more thereof. With the addition of the HC resin the thickness of the MDO polypropylene film can be reduced whilst appropriate mechanical stability such as stiffness, tensile strength, tear resistance and elongation properties of the film may be maintained. For example, HC resin addition increases the tensile strength and reduces the elongation in machine direction of the MDO polypropylene film. Reduced elongation of the plastic film used as a liner for labels is beneficial, among other things, in order to obtain optimum register control during the printing operation as well as exact placement of labels during the dispensing operation. Increased strength properties allow the film to be down gauged to a thickness of about 15-20 microns whilst maintaining excellent mechanical stability. Reduced film thickness provides savings in material costs.

Polypropylene and hydrocarbon raw materials used with the invention may be for example commercial materials like presented in the following Table 1.

TABLE 1
Commercial raw materials

| Material/Brand name | Company |
|---|---|
| Polypropylene homopolymer | |
| HC101BF | Borealis |
| HC110BF | Borealis |
| Moplen 1073 | Lyondell Basell |
| PP4352F1 | Exxon Mobil |
| Hydrocarbon resin | |
| Masterbatch MDPPH6040 | PolyOne |
| Masterbatch MDPPH6025 | PolyOne |
| Oppera | Exxon Mobil |

According to the invention the plastic film is stretched in machine-direction orientation process. Thus the film is monoaxially oriented. This oriented plastic film will also be designated as a MDO film hereinafter. Also other stretching methods may be used. Plastic films may be oriented or stretched approximately from 5 to 8 times in the machine direction. Orientation temperature may be approximately 20-40° C. below the melting temperature of the polypropylene homopolymer.

According to the invention MDO plastic film may be a monolayer film, also called as a single layer film, or a multilayer film. Prior to orientation process a monolayer film may be blown or cast film. The multilayer film may be for example co-extruded. During co-extrusion the different layers are formed simultaneously and firmly adhered to each other to provide a unitary coextrudate of multiple layers. It is also possible that at least two monolayer films with different composition and/or different degrees of orientation are laminated together or that MDO film is top coated to form a MDO multilayer film.

According to one embodiment of the invention MDO plastic film may also contain at least one filler material such as a mineral filler, for example silica in the form of particles. Other filler materials known in the art are also possible.

Filler is preferably used in a core layer of a multilayer film. An amount of filler may be from 2 to 50 weight-% or from 10 to 30 weight-% based on the total weight of the filled polymer. Addition of filler component will increase heat stability and mechanical stability of the plastic film. A certain degree of heat stability is required for example during the printing and die-cutting operation when the label laminate may reach a temperature of 50-60° C. At this elevated temperature also the elongation of the MDO film should be kept in a minimum. MDO plastic film which is loaded with the filler material will not be perfectly transparent but rather have a milky-white appearance. This kind of appearance will be beneficial especially when said MDO plastic film is used as a release liner for pressure sensitive labels. The milky-white appearance will be an advantage for the optical detection of the labels during the dispensing process.

According to the invention MDO plastic film is useful as a release liner in preparing laminate constructions for pressure-sensitive labels. At least the MDO plastic film surface adjacent to adhesive is further made repellent towards the adhesive layer. The MDO film surface may be coated with a controlled thickness of release agent, such as silicone polymer to form a release liner. Said release liner is easily recyclable and may further be reused in products such as in injection moulded polypropylene articles.

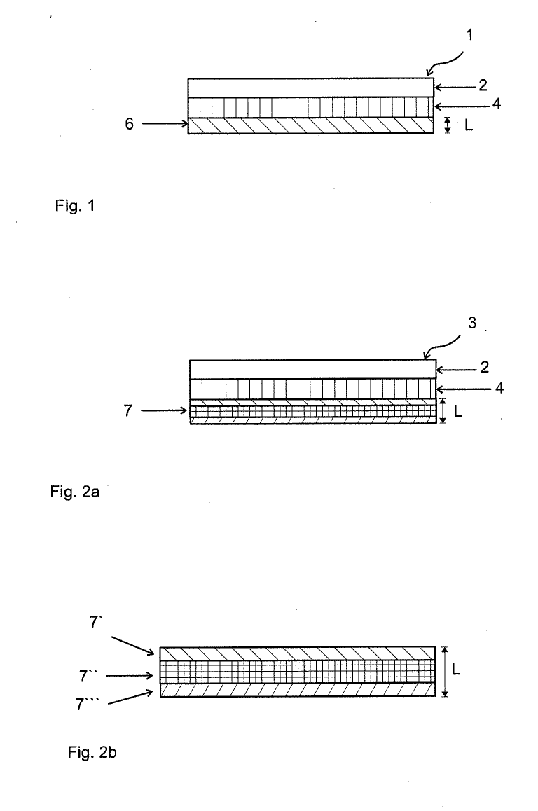

A pressure-sensitive label laminate construction 1 with a single layer release liner according to one example embodiment of the invention is presented in FIG. 1. In addition to the release liner 6 the structure may comprise at least an adhesive layer 4 and a face material layer (facestock) 2. The single layer release liner comprises only MDO monolayer plastic film. The monolayer MDO plastic film surface adjacent to the adhesive layer 4 is further coated with a releasing agent to form said release liner.

According to another example embodiment of the invention a pressure sensitive label laminate construction 3 with a multilayer release liner 7 is presented in a FIG. 2a. The multilayer release liner 7 comprises a multilayer plastic film which is further coated from the surface adjacent to the adhesive layer with a releasing agent. The multilayer plastic film may have a three layer structure which comprises a core layer 7″ and first 7′ and second 7′″ top layer on opposite sides of the core layer, as presented in FIG. 2b. Top layer may be also only on one side of the core layer. Top layers may be also referred to skin layers. The multilayer plastic film may be coextruded and oriented so that all the coextrudate layers, core and top layer(s), are oriented thus forming a totally machine direction oriented multilayer plastic film structure. The multilayer plastic film may also have a laminated or top coated structure. In this kind of laminated or top-coated multilayer structure at least one of the plastic film layers is machine direction oriented but it may also comprise non-oriented plastic film layer(s) and the formed multilayer plastic film structure is thus partially oriented. However laminated plastic film multilayer structure may also be a totally machine direction oriented if all the separate plastic film layers laminated together are MDO plastic films. A partially or totally machine direction oriented multilayer plastic film construction may also have five or more layers and may thus include an additional intermediate layer or several layers.

According to still one example embodiment of the MDO multilayer film only the core layer comprises a mixture of PP homopolymer as a main component and hydrocarbon (HC) resin as a minor component and other layers, like first and second top layer or intermediate layer(s), have different film compositions comprising for example different polymers and/or different additives as minor component. It is also possible that at least one top layer or intermediate layer include HC resin. The thickness of the core layer 7″ may be, for example approximately 80% or more of the total thickness L and/or weight of the multilayer film. The total thickness L of the multilayer or monolayer MDO plastic film is approximately from 15 to 35 microns or preferably around 20 microns. In order to provide a laminate construction for a pressure-sensitive labels the single layer or multilayer MDO release liner is further laminated at least with an adhesive layer and a face material layer.

1. A machine direction oriented plastic film as a release liner for a pressure-sensitive label, wherein the plastic film comprises a polypropylene homopolymer and a hydrocarbon resin.

2. The machine direction oriented plastic film according to claim 1, wherein the hydrocarbon resin is a hydrogenated, saturated aliphatic acyclic or saturated aliphatic cyclic hydrocarbon compound or mixture of two or more thereof.

3. The machine direction oriented plastic film according to claim 1, wherein an amount of hydrocarbon resin is from 3 to 20 weight-% or from 8 to 15 weight-%.

4. The machine direction oriented plastic film according to claim 1, wherein the film comprises mineral filler.

5. The machine direction oriented plastic film according to claim 4, wherein the amount of mineral filler is from 2 to 50 weight-% or from 10 to 30 weight-% based on the total weight of the filled polymer.

6. The machine direction oriented plastic film according to claim 1, wherein the plastic film is a monolayer film.

7. The machine direction oriented plastic film according to claim 1, wherein the plastic film has a totally or partially machine-direction oriented multilayer film structure.

8. The machine direction oriented plastic film according to claim 1, wherein the plastic film has a thickness from 15 to 35 microns, preferably around 20 microns.

9. A method for producing a release liner for pressure-sensitive label, the method comprising at least the following steps:
selecting at least one polypropylene homopolymer as one component,
selecting at least one hydrocarbon resin as another component,
selecting a relative amount of the at least one hydrocarbon resin in a mixture of the at least one polypropylene and at least one hydrocarbon resin,
mixing the at least one polypropylene homopolymer component and the at least one hydrocarbon resin component in said relative amount by melt processing to form a monolayer or multilayer plastic film,
orienting said plastic film in a machine direction; and
coating the machine-direction oriented plastic film with a releasing agent to form a release liner.

10. The method according to claim 9, wherein the plastic films are oriented in from 5 to 8 times in machine direction.
